(19) United States
(12) Patent Application Publication
(10) Pub. No.: US 2016/0315723 A1
(43) Pub. Date: Oct. 27, 2016

(54) INFORMATION-PROCESSING SYSTEM, TERMINAL DEVICE, AND PROCESSING METHOD THEREOF

(71) Applicant: Aplix IP Holdings Corporation, Tokyo (JP)

(72) Inventors: Ryu Koriyama, Tokyo (JP); Nobushige Yamada, Tokyo (JP)

(73) Assignee: Aplix IP Holdings Corporation, Tokyo (JP)

(21) Appl. No.: 15/133,161

(22) Filed: Apr. 19, 2016

(30) Foreign Application Priority Data
Apr. 27, 2015 (JP) 2015-090626

(51) Int. Cl. H04H 60/92; H04H 60/15; H04L 12/18

(52) U.S. Cl. CPC H04H 60/92; H04L 12/1845; H04L 12/189; H04H 60/15

(57) ABSTRACT

A receiver receives a beacon signal transmitted from a beacon device. A processing unit maintains an application in an operating state after a detection of entering or exiting a reception area of the beacon signal that satisfies a waiting condition until a predetermined time period has passed. A storage unit stores a comprehensive waiting condition and an individual waiting condition as the waiting conditions of the beacon signal, the comprehensive waiting condition comprehensively indicating the identification information different from one another, and the individual waiting condition individually indicating a single piece of the identification information. The processing unit causes the storage unit to store the identification information of the beacon signal as the individual waiting condition, in a case where the processing unit detects entering the reception area of the beacon signal that satisfies the comprehensive waiting condition.

### CROSS-REFERENCE TO RELATED APPLICATION

This application claims the benefit of priority to Japanese Patent Application No. 2015-090626, filed Apr. 27, 2015, of which full contents are incorporated herein by reference.

### BACKGROUND OF THE INVENTION

1. Field of the Invention

The present invention relates to a technique to perform processes relating to a beacon signal. More particularly, the present invention relates to an information-processing system that performs processes corresponding to the beacon signal, a terminal device, and a processing method thereof.

2. Description of the Related Art

In association with the spread of terminal devices that have a communication function, a system where an electronic device is coupled to a terminal device to transmit information from the electronic device to the terminal device has been used. Especially, a system where a beacon device transmits the beacon signal of proximity wireless communication to be used for a presentation of some information has been attracting attention. For example, a data communication system where the beacon signal is used to detect a purchaser side device coming close to a selling store and begin the communication between a vendor side device and the purchaser side device for advertising commodities has been proposed (refer to such as Japanese Unexamined Patent Application Publication No. 2000-134147). A system where a power state of the terminal device is shifted to a power-saving state corresponding to the transition of the current position due to the movement to reduce the power consumption of the terminal device has been also proposed (refer to such as Japanese Unexamined Patent Application Publication No. 2015-045573).

When the beacon signal transmitted from the beacon device is used for the information presentation, for example, there is possibly a case where the information is presented when the terminal device comes within a predetermined distance from the beacon device. However, it is a problem that, in the case where an application operated on the terminal device has transitioned to the power-saving state, the process for the information presentation cannot be performed. Especially, when starting to receive the beacon signal triggers the application to be in the operating state, the operating state may possibly fail to be appropriately maintained under the condition where coverages of reception of a plurality of the beacon signals are overlapping with one another.

### BRIEF SUMMARY OF THE INVENTION

An aspect of the present invention is an information-processing system that includes a beacon device and a terminal device. The beacon device transmits a beacon signal that includes identification information. The terminal device causes an application to operate to perform processes relating to the beacon signal. The terminal device includes a receiver, a storage unit, and a processing unit. The receiver receives the beacon signal. The storage unit stores the identification information of the beacon signal being a waiting object, as a waiting condition. The processing unit maintains the application in an operating state after a detection of entering or exiting a reception area of the beacon signal that satisfies the waiting condition until a predetermined time period has passed. The storage unit stores a comprehensive waiting condition that comprehensively indicates the identification information different from one another and an individual waiting condition that individually indicates a single piece of the identification information as the waiting conditions. The processing unit causes the storage unit to store the identification information of the beacon signal as the individual waiting condition, in a case where the processing unit detects entering the reception area of the beacon signal that satisfies the comprehensive waiting condition.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a drawing illustrating an outline of an information-processing system according to embodiments of the present invention;

FIG. 2 is a drawing illustrating an exemplary configuration of an information-processing system according to a first embodiment of the present invention;

FIG. 3 is a drawing illustrating an exemplary field configuration of a beacon signal according to embodiments of the present invention;

FIG. 4 is a drawing illustrating an exemplary arrangement of beacon devices 200 according to embodiments of the present invention;

FIG. 5 is a drawing illustrating an exemplary waiting condition list 121 according to the first embodiment of the present invention;

FIG. 6 is a flowchart illustrating an exemplary procedure in a case where a terminal device enters a reception area of a comprehensive waiting condition according to embodiments of the present invention;

FIG. 7 is a flowchart illustrating an exemplary procedure in a case where a terminal device exits a reception area of an individual waiting condition according to embodiments of the present invention;

FIG. 8 is a flowchart illustrating an exemplary procedure of a pause timer 160 in a case where a timeout occurs according to embodiments of the present invention;

FIG. 9 is a flowchart illustrating an exemplary procedure of an application according to embodiments of the present invention;

FIG. 10 is a drawing illustrating an exemplary arrangement of the beacon device according to embodiments of the present invention;

FIG. 11 is a sequence diagram illustrating an exemplary operation in a case where the timeout occurs at a point C in the exemplary arrangement in FIG. 10 according to embodiments of the present invention;

FIG. 12 is a sequence diagram illustrating an exemplary operation in a case where the timeout does not occur at the point C in the exemplary arrangement in FIG. 10 according to embodiments of the present invention;

FIG. 13 is a drawing illustrating an exemplary configuration of a beacon device 200 according to a second embodiment of the present invention;

FIG. 14 is a drawing illustrating an exemplary transition of identification information 221 in the beacon device 200 according to the second embodiment of the present invention;

FIG. 15 is a flowchart illustrating an exemplary procedure of the beacon device 200 according to the second embodiment of the present invention; and

FIG. 16 is a drawing illustrating another exemplary arrangement of the beacon device according to embodiments of the present invention.

### DETAILED DESCRIPTION OF THE INVENTION

The following describes embodiments of the present invention (hereinafter referred to as embodiments).

### 1. First Embodiment

### System Configuration

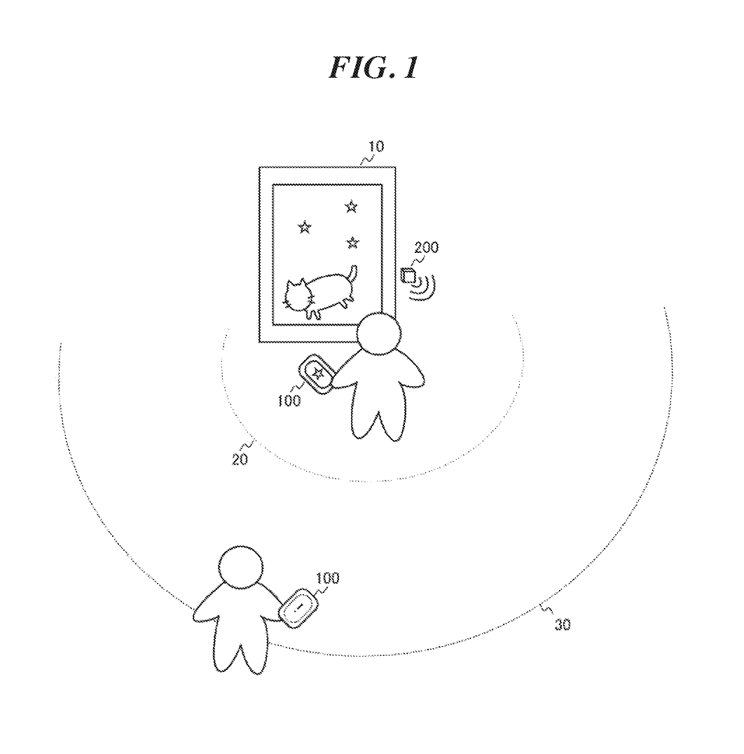

FIG. 1 is a drawing illustrating an outline of an information-processing system according to embodiments of the present invention. FIG. 1 indicates an exhibit 10 disposed in a facility such as an art museum or a department store.

A beacon device 200 that corresponds to the exhibit 10 is installed beside the exhibit 10. The beacon device 200 is a device that wirelessly transmits beacon signals intermittently at predetermined time intervals. The beacon signal transmitted from the beacon device 200 is received by a terminal device 100 that a user carries. The terminal device 100 includes, for example, a mobile terminal, a tablet personal computer, and others.

An area where the terminal device 100 can receive the beacon signal transmitted from the beacon device 200 is indicated as a reception area 30. The reception area 30 can be assumed to be a range, for example, within a radius of ten meters from the beacon device 200.

An area where an application that operates on the terminal device 100 performs predetermined operations in response to the beacon signal is indicated as a reaction area 20. The reaction area 20 can be assumed to be a range, for example, within a radius of one meter from the beacon device 200. As the predetermined operation by the application, for example, an operation to display a pop-up notice relating to the exhibit 10 on the terminal device 100 can be assumed.

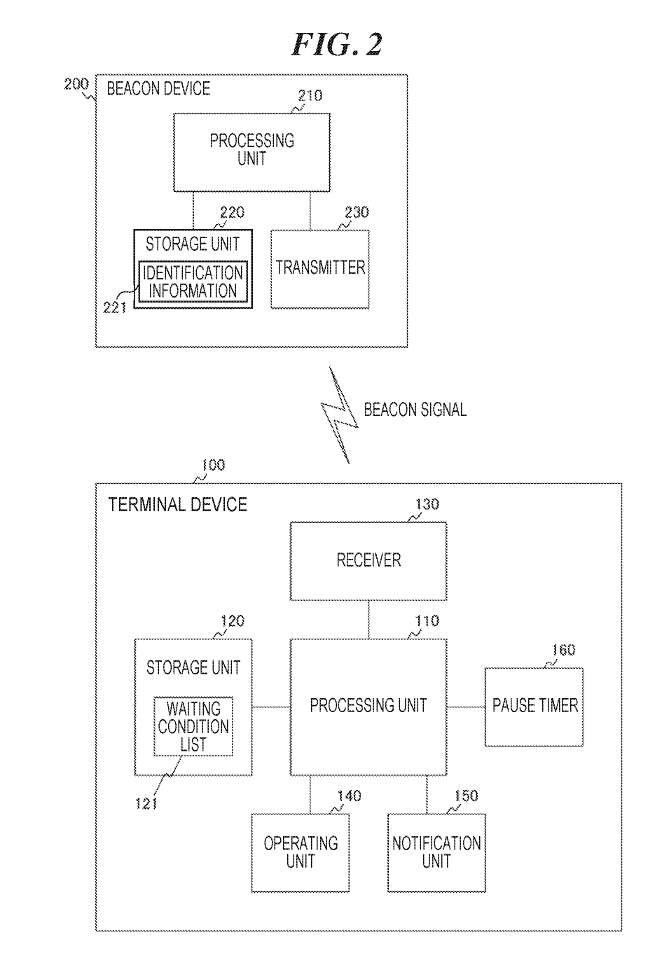

FIG. 2 is a drawing illustrating an exemplary configuration of an information-processing system according to a first embodiment of the present invention. The information-processing system includes the above-described beacon device 200 and terminal device 100. The beacon device 200 includes a processing unit 210, a storage unit 220, and a transmitter 230. The terminal device 100 includes a processing unit 110, a storage unit 120, a receiver 130, an operating unit 140, a notification unit 150, and a pause timer 160.

The processing unit 210 in the beacon device 200 performs necessary processes to operate the beacon device 200. The storage unit 220 in the beacon device 200 stores necessary data to operate the beacon device 200. Here, the storage unit 220 stores identification information 221 to identify the beacon signal transmitted from the beacon device 200. The transmitter 230 transmits the beacon signal including the identification information 221 as a wireless signal.

The processing unit 110 in the terminal device 100 performs necessary processes to operate the terminal device 100. The processing unit 110 executes the operating system and the application.

The storage unit 120 in the terminal device 100 stores necessary data to operate the terminal device 100. Here, the storage unit 120 stores a waiting condition list 121 that includes conditions for the beacon signal as a waiting object in the terminal device 100.

The receiver 130 receives the beacon signal from the beacon device 200. The receiver 130 has a function to measure a received signal strength (RSSI: Received Signal Strength Indication) of the received beacon signal. This enables the terminal device 100 to determine whether or not the terminal device 100 has entered the reaction area 20 as described later.

The operating unit 140 accepts operation inputs from a user. The notification unit 150 notifies or presents information to the user by images and sounds.

The pause timer 160 measures a time period until timing when the terminal device 100 transitions from an operating state to a pause state. As described later, the pause timer 160 is reset in accordance with the terminal device 100 entering and exiting the reception area 30, and starts measuring the time period. Then, the terminal device 100 transitions to the pause state at the timing when the pause timer 160 finishes measuring a predetermined time period for timeout. As the predetermined time period for timeout, for example, approximately three minutes can be assumed.

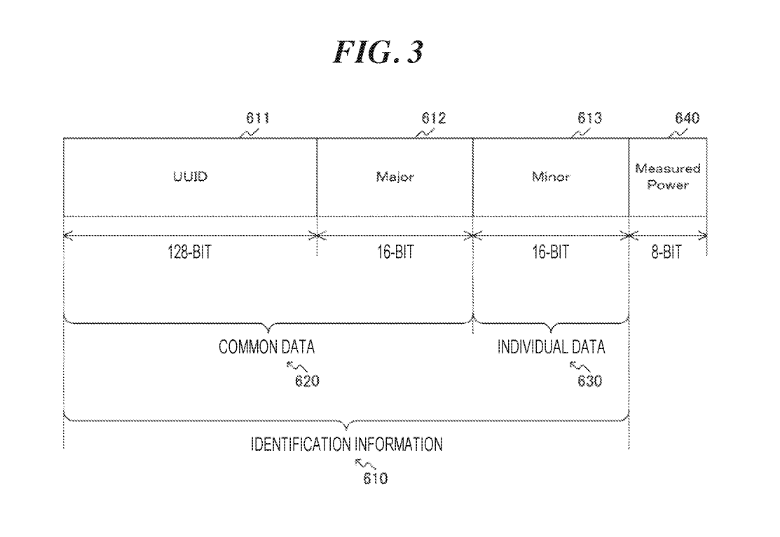

FIG. 3 is a drawing illustrating an exemplary field configuration of the beacon signal according to embodiments of the present invention. This embodiment assumes a communication in accordance with Bluetooth (registered trademark) Low Energy (hereinafter referred to as “BLE”) standard. The BLE is a technique to transmit small size data (approximately 20 bytes) to wireless communication terminals nearby in short range. Other communication standards such as Wi-Fi (registered trademark) standard may be employed to wirelessly transmit the beacon signal insofar as the beacon signal can be transmitted to the terminal device 100 based on the other communication standards.

The beacon signal according to the embodiment is assumed to include four pieces of information of a UUID 611, a Major 612, a Minor 613, and a Measured Power 640.

The Universally Unique Identifier (UUID) 611 is a universal unique identifier of 128-bit, and used to identify a company and similar organization managing the information-processing system.

The Major 612 and the Minor 613 are sections used for the company and similar organization identified by the UUID 611. Each of the Major 612 and the Minor 613 has 16-bit width. This embodiment assumes that the identifiers common to the beacon signals used for the information-processing system are set in the Major 612, and the identifiers specific to each beacon signal are set in the Minor 613. That is, a total 144-bit of the UUID 611 and the Major 612 shows a common value in the information-processing system. Then, the total 144-bit will be referred to as common data 620. In contrast, the Minor 613 shows the individual identifiers of the beacon signals. Then, the Minor 613 will be referred to as individual data 630. Then, the common data 620 and the individual data 630 are collectively used as identification information 610 of the beacon signal.

The Measured Power 640 is a section of 8-bit that shows the received signal strength (RSSI) at the position with a distance of one meter from the beacon device 200. The terminal device 100 measures the received signal strength of the received beacon signal to compare with the value of the Measured Power 640. This enables the terminal device 100 to determine whether or not the distance from the beacon device 200 is within one meter, that is, whether or not within the reaction area 20.

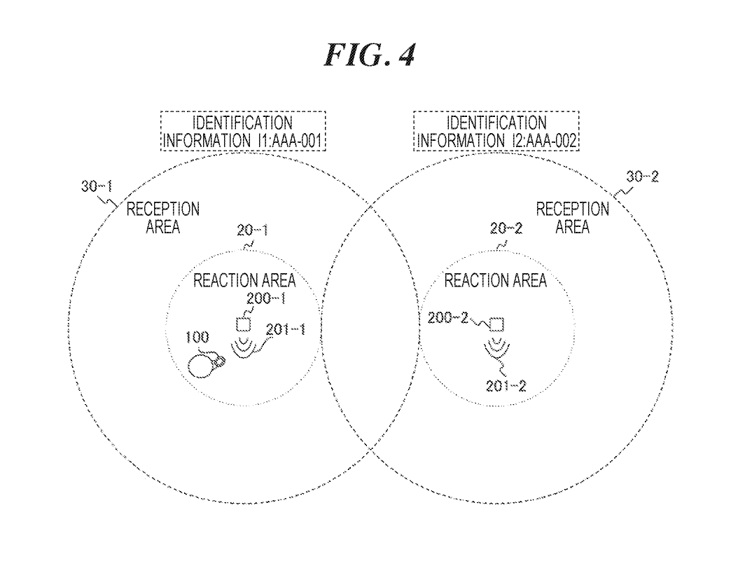

FIG. 4 is a drawing illustrating an exemplary arrangement of the beacon devices 200 according to embodiments of the present invention. In this example, two beacon devices 200-1 and 200-2 are installed, and it is assumed that reception areas 30-1 and 30-2 of the beacon devices 200-1 and 200-2 are overlapping with one another.

It is assumed that identification information I1 of a beacon signal 201-1 transmitted from the beacon device 200-1 is “AAA-001,” and identification information I2 of a beacon signal 201-2 transmitted from the beacon device 200-2 is “AAA-002.” Here, the part “AAA” corresponds to the common data 620, and the part “001” or “002” corresponds to the individual data 630 of the beacon signal 201-1 or 201-2, respectively.

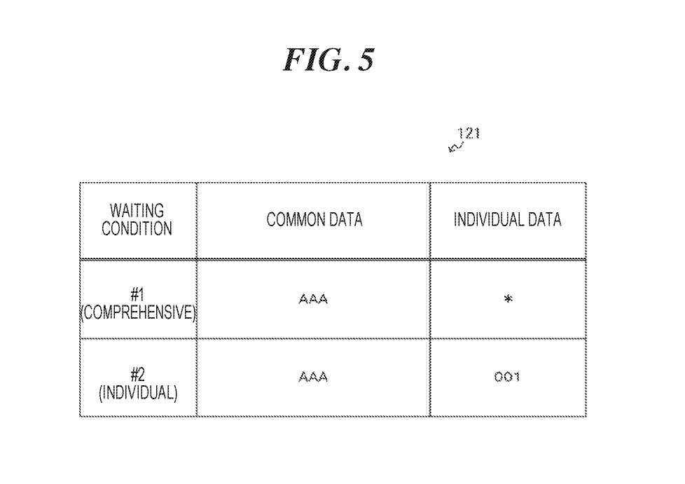

FIG. 5 is a drawing illustrating an exemplary waiting condition list 121 according to the first embodiment of the present invention. The waiting condition list 121 stores a first waiting condition (#1) and a second waiting condition (#2). This example assumes a case where the waiting condition list 121 is configured in accordance with the exemplary arrangement of the beacon device 200 in FIG. 4.

While the first waiting condition specifies the common data 620 to “AAA,” the individual data 630 is indicated by “*” that means not to be specified. That is, the first waiting condition is a comprehensive waiting condition that comprehends the beacon signals with “AAA” of the common data 620 in the information-processing system. Accordingly, if the terminal device 100 receives any of the beacon signals in the information-processing system, the first waiting condition is satisfied. It is necessary for the first waiting condition to be preliminarily fixed and set when the information-processing system is operated such that the terminal device 100 can receive the beacon signal from the beacon device 200 belonging to the information-processing system.

The second waiting condition is a condition where the common data 620 is “AAA” and the individual data 630 is “001.” That is, the second waiting condition is an individual waiting condition where the beacon signal 201-1 from the beacon device 200-1 is individually specified. Accordingly, only in the case where the terminal device 100 receives the beacon signal 201-1, the second waiting condition is satisfied. It is not necessary for the second waiting condition to be preliminarily set when the information-processing system is operated. As described later, the second waiting condition is dynamically set when the terminal device 100 enters the reception area 30 of the beacon signal, and varies corresponding to a reception state of the beacon signal.

### [Procedure]

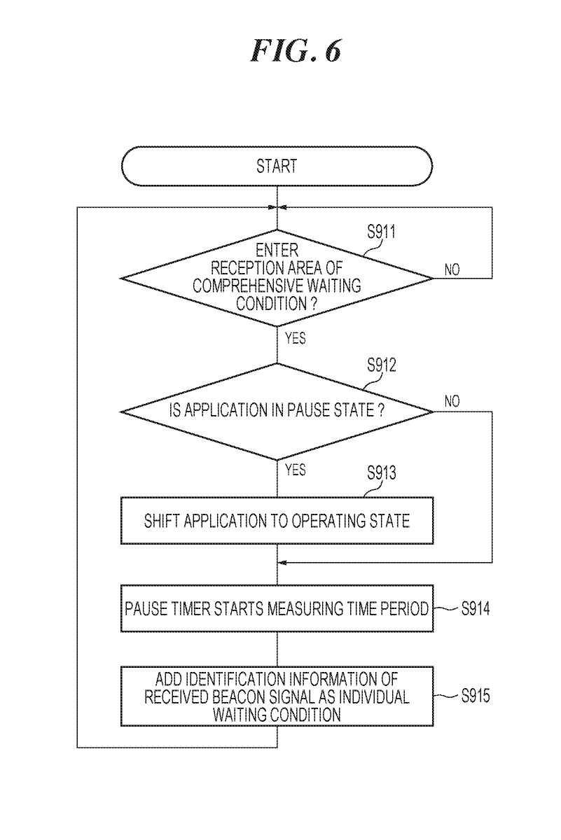

FIG. 6 is a flowchart illustrating an exemplary procedure in a case where the terminal device 100 enters the reception area of the comprehensive waiting condition according to embodiments of the present invention. Here, a configuration where a comprehensive waiting condition including “AAA” as the common data 620 and “*” as the individual data 630 is preliminarily set as the first waiting condition is assumed.

When the terminal device 100 enters the reception area of the comprehensive waiting condition as the first waiting condition of the waiting condition list 121 (Step S911: Yes), the procedure is started. That is, when a state where the terminal device 100 does not receive the beacon signal that satisfies the comprehensive waiting condition is changed to a state where the terminal device 100 receives the beacon signal, the following processes are performed. For example, when the terminal device 100 enters the reception area 30-1 of the beacon device 200-1, the terminal device 100 receives the beacon signal with “AAA-001” as the identification information 610. This beacon signal satisfies the comprehensive waiting condition.

At this time, in a case where the application is in the pause state in the terminal device 100 (Step S912: Yes), the operating system shifts the application to the operating state (Step S913). In a case where the application is already in the operating state (Step S912: No), the operating state is maintained as it is.

Next, the operating system resets the pause timer 160 to start measuring the time period (Step S914). Then, the application adds the value of the identification information 610 of the received beacon signal to the second waiting condition of the waiting condition list 121 as the individual waiting condition (Step S915). For example, when the terminal device 100 receives the beacon signal with “AAA-001” as the identification information 610, the value of “AAA” and the value of “001” are added to the common data and the individual data of the second the waiting condition of the waiting condition list 121, respectively.

At this time, in a case where the terminal device 100 receives a plurality of the beacon signals, the beacon signal with the largest value of the received signal strength (RSSI) is chose to be added. That is, this aims to choose the beacon signal transmitted from the nearest beacon device.

After these processes are terminated, the procedure is idle until the next time when the terminal device 100 enters the reception area of the comprehensive waiting condition again (Step S911).

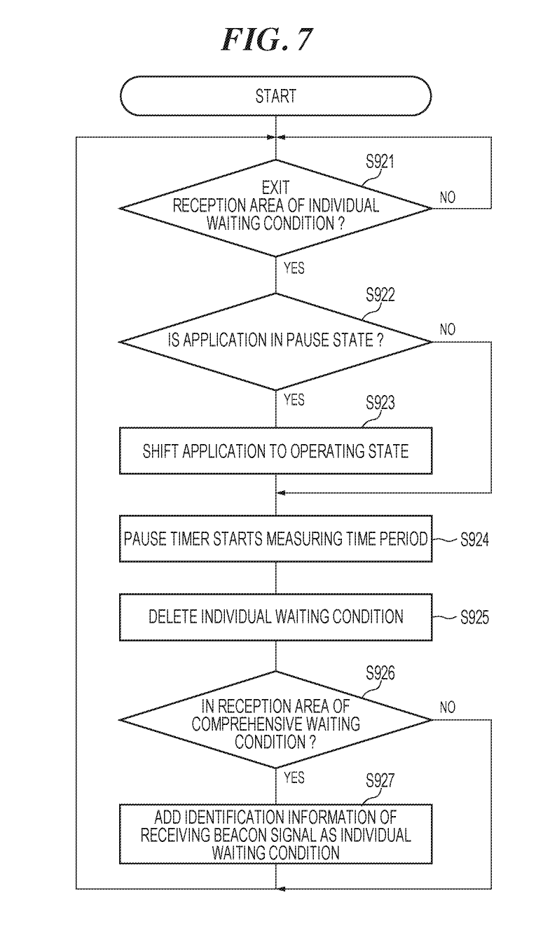

FIG. 7 is a flowchart illustrating an exemplary procedure in a case where the terminal device 100 exits the reception area of the individual waiting condition according to embodiments of the present invention.

When the terminal device 100 exits the reception area of the individual waiting condition as the second waiting condition of the waiting condition list 121 (Step S921: Yes), the procedure is started. That is, when a state where the terminal device 100 receives the beacon signal that satisfies the individual waiting condition is changed to a state where the terminal device 100 does not receive the beacon signal, the following processes are performed. For example, in a state where the terminal device 100 has received the beacon signal with “AAA-001” as the identification information 610, when the terminal device 100 fails to receive the beacon signal for a predetermined period, the terminal device 100 is presumed to have exited the reception area 30-1 of the beacon signal. In this case, the predetermined period can be assumed to, for example, approximately 30 seconds.

At this time, in a case where the application is in the pause state in the terminal device 100 (Step S922: Yes), the operating system shifts the application to the operating state (Step S923). In a case where the application is already in the operating state (Step S922: No), the operating state is maintained as it is.

Next, the operating system resets the pause timer 160 to start measuring the time period (Step S924). Then, the application deletes the individual waiting condition that is detected to exit the reception area of the beacon signal from the waiting condition list 121 (Step S925).

At this time, if the terminal device 100 is still in the reception area that satisfies the comprehensive waiting condition (Step S926: Yes), the application adds the value of the identification information 610 of the receiving beacon signal to the second waiting condition of the waiting condition list 121 as the individual waiting condition (Step S927). Thus the identification information of the receiving beacon signal can be set as the individual waiting condition and the pause timer 160 can be started, in a case where, at the time when the terminal device 100 exits one reception area, the terminal device 100 has already entered the other reception area if a plurality of beacon devices with overlapping reception areas of the beacon signal are disposed as illustrated in FIG. 4.

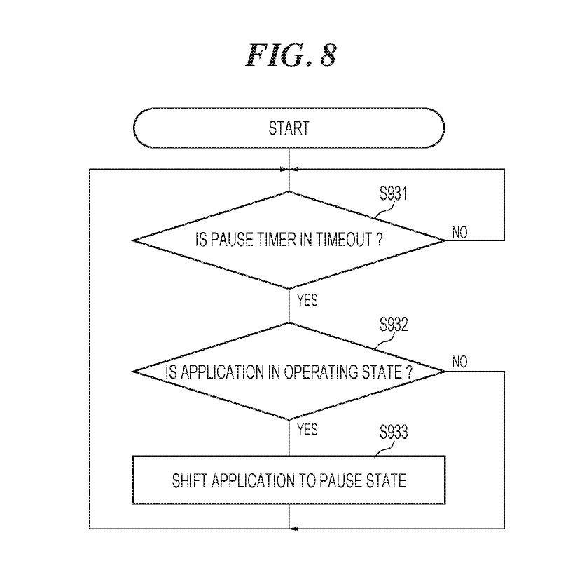

FIG. 8 is a flowchart illustrating an exemplary procedure of the pause timer 160 in a case where a timeout occurs according to embodiments of the present invention.

When the pause timer 160 measure the predetermined time period for timeout and the timeout occurs (Step S931: Yes), the timeout is notified to the operating system to generate an interruption. At the time, if the application is in the operating state (Step S932: Yes), the operating system shifts the application to the pause state (Step S933).

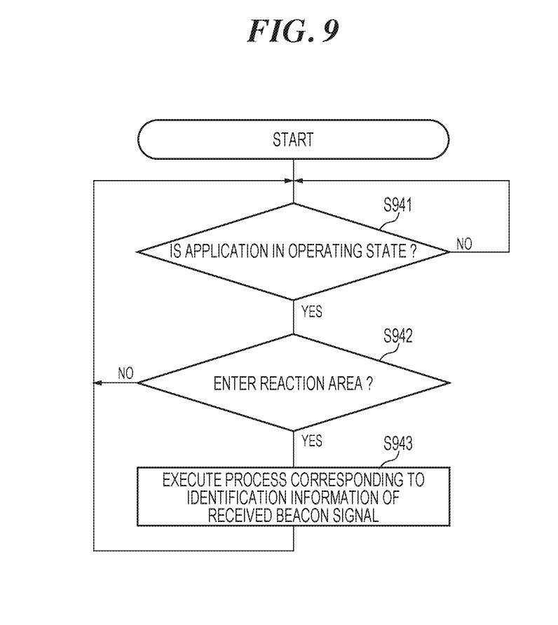

FIG. 9 is a flowchart illustrating an exemplary procedure of the application according to embodiments of the present invention.

The application is in any one of the operating state or the pause state. The pause state contributes to saving power without performing any particular operation. The operating system shifts the application to the operating state in the above-described Steps S913 or S923. At the time, the pause timer 160 starts measuring the time period. When the pause timer 160 measure the time period until the timeout, the operating system shifts the application to the pause state in the above-described Step S933.

When the application is in the operating state (Step S941: Yes), the application determines whether or not the terminal device 100 enters the reaction area 20 of the beacon signal (Step S942). When the application detects the terminal device 100 entering the reaction area 20 of the beacon signal (Step S942: Yes), the application executes the process corresponding to the identification information 610 of the beacon signal (Step S943). As the process corresponding to the identification information 610, for example, the presentation of the information relating to the exhibit 10 that is installed near the beacon device 200 transmitting the beacon signal including the identification information 610 or the like is assumed.

### [Exemplary Operation]

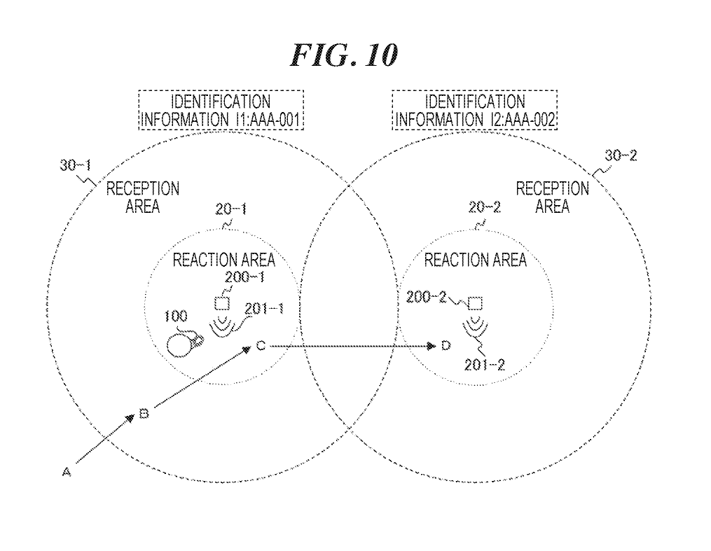

FIG. 10 is a drawing illustrating an exemplary arrangement of the beacon device according to embodiments of the present invention. This example of the arrangement is similar to that in FIG. 4, and the reception areas 30-1 and 30-2 of the beacon devices 200-1 and 200-2 are overlapping with one another. The following describes exemplary operations of the operating system and the application in accordance with the move of the terminal device 100. In this example, the terminal device 100 moves in the order of a point A, a point B, a point C, and a point D.

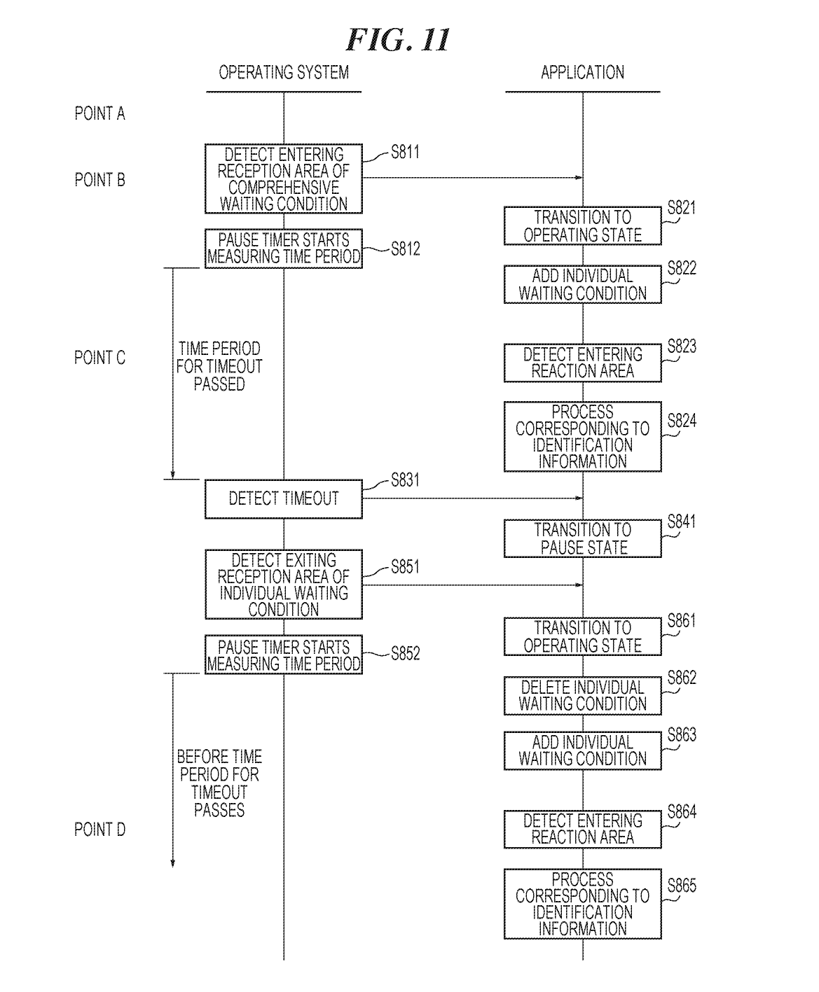

FIG. 11 is a sequence diagram illustrating an exemplary operation in a case where the timeout occurs at the point C in the exemplary arrangement in FIG. 10 according to embodiments of the present invention.

When the terminal device 100 moves from the point A to the point B to enter the reception area 30-1 of the beacon device 200-1, the operating system detects the terminal device 100 entering the reception area that satisfies the comprehensive waiting condition (Step S811). At this time, if the application is assumed to be in the pause state, the operating system shifts the application to the operating state (Step S821). The operating system resets the pause timer 160 to start measuring the time period (Step S812). The application adds the value “AAA-001” of the identification information 610 of the receiving beacon signal to the second waiting condition of the waiting condition list 121 as the individual waiting condition (Step S822).

Assuming that the pause timer 160 does not measure the time period until the timeout when the terminal device 100 moves from the point B to the point C, the application detects the terminal device 100 entering the reaction area 20-1 of the beacon device 200-1 (Step S823). This causes the application to execute the process corresponding to the identification information 610 of the beacon signal (Step S824).

Then, when the pause timer 160 measures the predetermined time period for timeout and the timeout occurs, the operating system detects the timeout (Step S831). This causes the operating system to shift the application to the pause state (Step S841). If the pause timer 160 measures the time period until the timeout before the terminal device 100 enters the reaction area 20-1, the application cannot execute the process of Step S824 because the application transitions to the pause state at the time of the timeout.

When the terminal device 100 exits the reception area 30-1, the operating system detects the terminal device 100 exiting the reception area that satisfies the individual waiting condition (Step S851). At this time, if the application is assumed to be in the pause state, the operating system shifts the application to the operating state (Step S861). The operating system resets the pause timer 160 to start measuring the time period (Step S852). Then, the application deletes the individual waiting condition “AAA-001” that is detected to have exited the reception area of the beacon signal from the waiting condition list 121 (Step S862). At this time, if the terminal device 100 is assumed to be in the reception area 30-2, the application adds the value “AAA-002” of the identification information 610 of the receiving beacon signal to the second waiting condition of the waiting condition list 121 as the individual waiting condition (Step S863).

Assuming that the pause timer 160 does not measure the time period until the timeout when the terminal device 100 moves to the point D, the application detects the terminal device 100 entering the reaction area 20-2 of the beacon device 200-2 (Step S864). This causes the application to execute the process corresponding to the identification information 610 of the beacon signal (Step S865).

In this example, in a state where the predetermined time period for timeout has passed since the terminal device 100 entered the reception area 30-1, the pause timer 160 is reset at the time when the terminal device 100 exits the reception area 30-1. Thus, entrance of the terminal device 100 into the reaction area 20-2 can be detected, and the process corresponding to the value “AAA-002” of the identification information 610 can be executed.

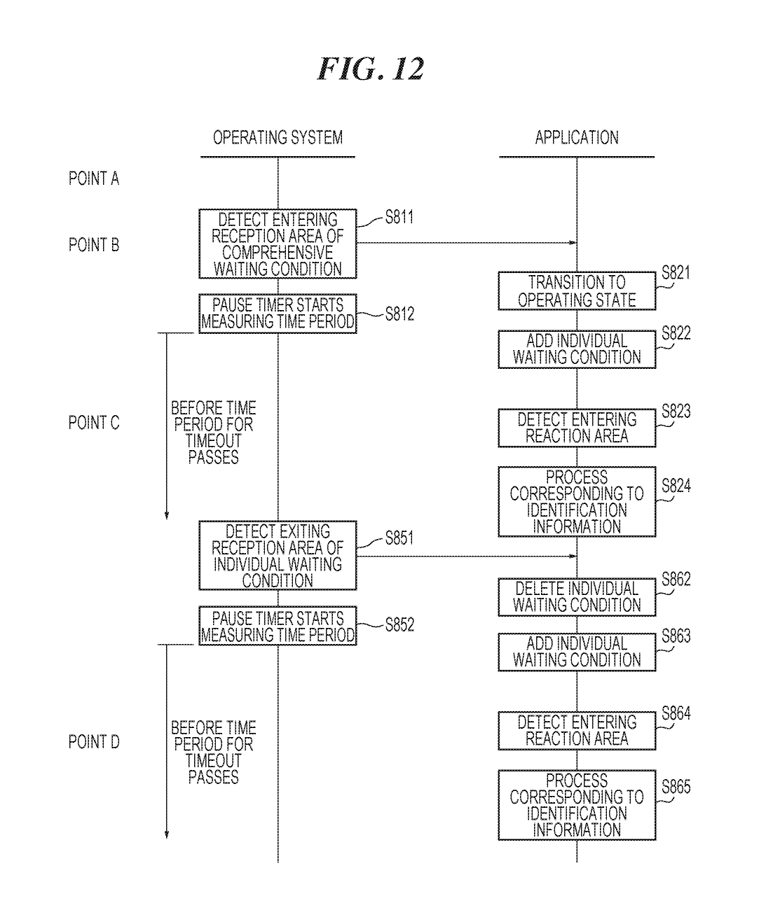

FIG. 12 is a sequence diagram illustrating an exemplary operation in a case where the timeout does not occur at the point C in the exemplary arrangement in FIG. 10 according to embodiments of the present invention. The operations where the operating system detects the terminal device 100 entering the reception area that satisfies the comprehensive waiting condition (Step S811), and then, the application executes the process corresponding to the identification information 610 of the beacon signal (Step S824) are similar to those in FIG. 11. Then, the description of the processes from Step S811 to Step S824 will be omitted.

When the terminal device 100 exits the reception area 30-1, the operating system detects the terminal device 100 exiting the reception area that satisfies the individual waiting condition (Step S851). At this time, the state of the application is not changed because the application is in the operating state. The processes thereafter are similar to those in FIG. 11, then, the description will be omitted.

In this example, while the timeout does not occur at the point C, the pause timer 160 is reset at the time when the terminal device 100 exits the reception area 30-1. This enables the application to detect the terminal device 100 entering the reaction area 20-2. Then, the application can execute the process corresponding to the value “AAA-002” of the identification information 610.

Thus, according to the first embodiment of the present invention, regardless of whether or not the predetermined time period for timeout has passed since the terminal device 100 entered the reception area that satisfies the comprehensive waiting condition, the pause timer 160 is reset when the terminal device 100 exits the reception area that satisfies the individual waiting condition. This enables the application to detect the terminal device 100 entering another reaction area. Then, the application can execute the processes corresponding to the value of the identification information 610.

### 2. Second Embodiment

According to the above-described first embodiment, the pause timer 160 is reset when the terminal device 100 exits the reception area that satisfies the individual waiting condition. This prevents the terminal device 100 from transitioning to the pause state. However, when the terminal device 100 does not exit the reception area that satisfies the individual waiting condition during a long stay of the terminal device 100 in the reception area that satisfies the comprehensive waiting condition, the timeout occurs. This hinders the application from detecting the terminal device 100 entering the reaction area. Therefore, in this second embodiment, the terminal device 100 controls the pause timer 160 so as to be appropriately reset during a long stay in the reception area that satisfies the comprehensive waiting condition.

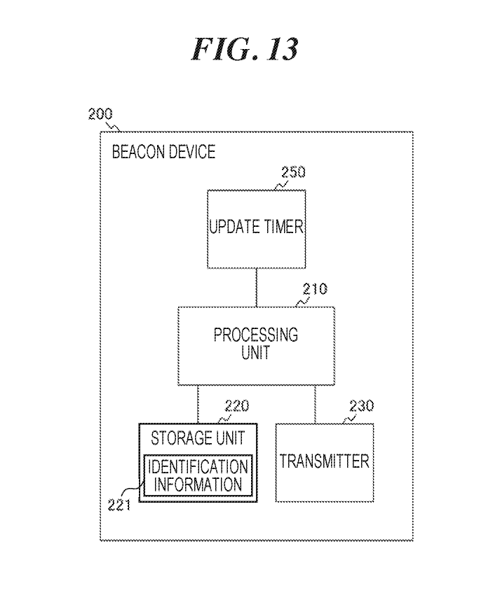

FIG. 13 is a drawing illustrating an exemplary configuration of a beacon device 200 according to the second embodiment of the present invention. The terminal device 100 that is similar to the terminal device 100 described in the first embodiment can be used.

The beacon device 200 in the second embodiment includes a processing unit 210, a storage unit 220, and a transmitter 230, and in addition to those, an update timer 250. The update timer 250 is a timer that generates an update timing of identification information 221 stored in the storage unit 220. The configuration other than this is similar to the configuration of the first embodiment.

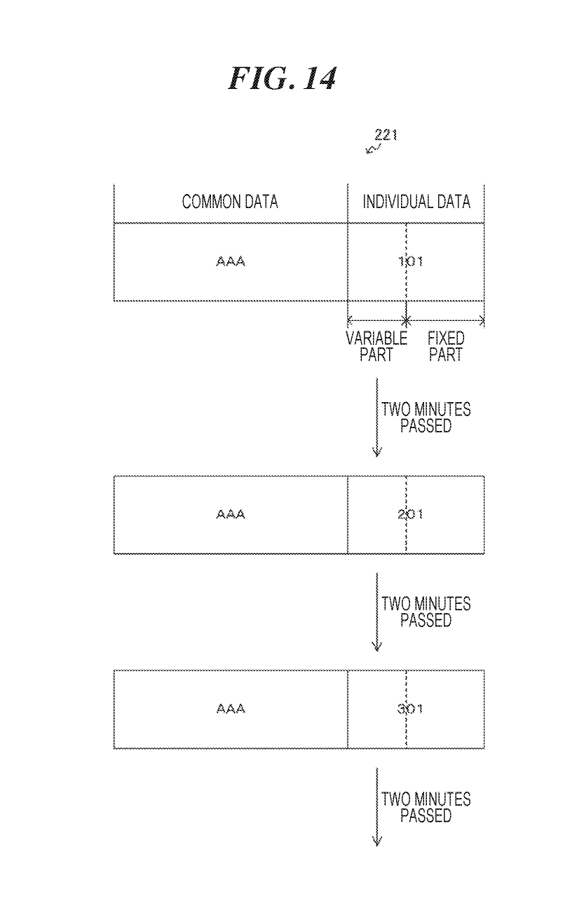

FIG. 14 is a drawing illustrating an exemplary transition of the identification information 221 in the beacon device 200 according to the second embodiment of the present invention. In the second embodiment, the individual data of the identification information 221 includes a fixed part and a variable part. While the fixed part is maintained without changes, the variable part is changed every time that the update timer 250 measures a predetermined time period for updating.

The example in FIG. 14 indicates the variable part that is changed every two minutes as the predetermined time period for updating. To update the variable part, for example, a counter may be disposed such that the counter counts up by one every time that the update timer 250 measures the predetermined time period for updating.

When the identification information is changed, the terminal device 100 starts receiving the beacon signal that includes the identification information different from the identification information included in the beacon signal that has been received so far. Then, the terminal device 100 interprets this as failing to receive the beacon signal that has been received so far, and determines that the terminal device 100 has exited the reception area of the individual waiting condition. As a result, the pause timer 160 is reset as described in the first embodiment (Step S924 in FIG. 7) to prevent the application from transitioning to the pause state.

In a case where the application executes the process corresponding to the identification information when the terminal device 100 enters the reaction area (Step S943 in FIG. 9), it is necessary to treat the common data and the fixed part of the individual data as the identification information, excepting the variable part. This is because, if the variable part is included, the process similar to the process performed in the case where the terminal device 100 enters another reaction area is repeatedly performed every time that the identification information is changed even in a state where the terminal device 100 stays in the reaction area of the identical beacon device.

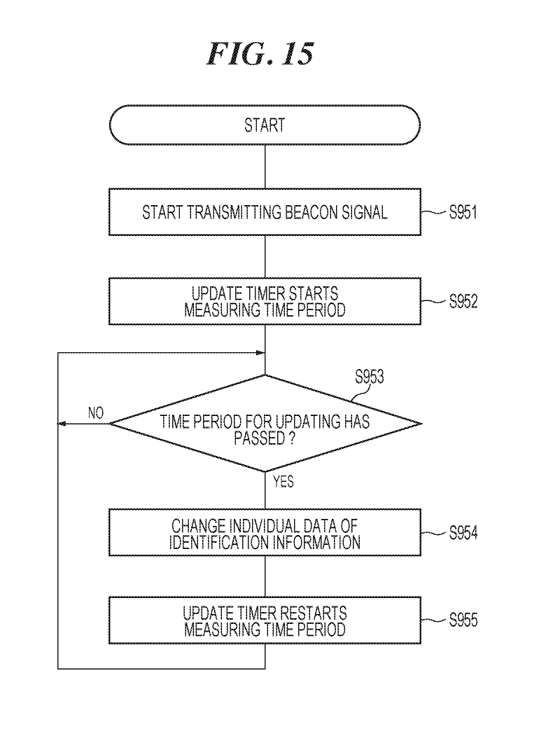

FIG. 15 is a flowchart illustrating an exemplary procedure of the beacon device 200 according to the second embodiment of the present invention. The operations of the terminal device 100 are similar to those of the first embodiment. Then, the description of the procedure will be omitted.

The processing unit 210 of the beacon device 200 starts transmitting the beacon signal from the transmitter 230 (Step S951), and resets the update timer 250 to start measuring the predetermined time period for updating (Step S952).

Subsequently, every time that the update timer 250 measures the predetermined time period for updating (Step S953: Yes), the processing unit 210 changes the variable part of the individual data of the identification information 221 (Step S954). Then, the processing unit 210 resets the update timer 250 to restart measuring the predetermined time period for updating (Step S955).

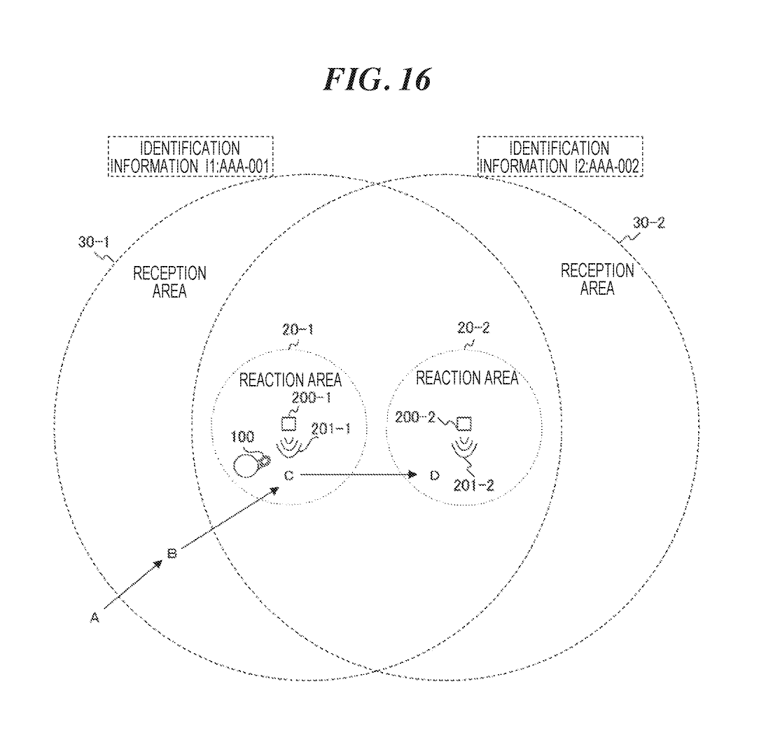

FIG. 16 is a drawing illustrating another exemplary arrangement of the beacon device according to embodiments of the present invention. While this exemplary arrangement includes two beacon devices 200-1 and 200-2, as well as the example in FIG. 4, this exemplary arrangement is different from the example in FIG. 4 in that both reception areas 30-1 and 30-2 of each beacon device include both reaction areas 20-1 and 20-2. That is, even if the pause timer 160 is configured to be reset when the terminal device 100 exits the reception area that satisfies the individual waiting condition as in the first embodiment, in this example, the predetermined time period for timeout may possibly pass because the terminal device 100 does not exit or enter one reception area before additionally entering the reaction area.

For example, in a case where the terminal device 100 moves from the point A to the point B, the operating system detects the terminal device 100 entering the reception area that satisfies the comprehensive waiting condition to reset the pause timer 160. In the above-described first embodiment, in a case where the predetermined time period for timeout has passed when the terminal device 100 moves from the point C to the point D, the application cannot detect the terminal device 100 entering the reaction area 20-2. In contrast, in the second embodiment, even after the terminal device 100 enters the reception area that satisfies the comprehensive waiting condition, the identification information of the beacon signal is changed every time that the update timer 250 measures the predetermined time period for updating. Therefore, it is determined that the beacon signal including the identification information received so far has not been received for a predetermined time period (approximately 30 seconds, for example). Accordingly, the pause timer 160 is reset every time that the predetermined time period for updating has passed. This enables the application to be prevented from transitioning to the pause state even if the terminal device 100 does not exit or enter the reception area.

Thus, according to the second embodiment of the present invention, the pause timer 160 is reset every time that the update timer 250 measures the predetermined time period for updating. This prevents timeout in the pause timer 160, and the application can be maintained in the operating state.

The above-described embodiments are merely examples that embody the present invention. Each matter in the embodiments corresponds to each matter specifying the invention of the claims. Similarly, each matter specifying the invention of the claims corresponds to each matter in the embodiments of the present invention that has an identical name to the matter specifying the invention of the claims. However, the present invention is not limited to the embodiments, and can be embodied in various configurations without departing from the scope of the present invention.

The procedures described in the above-described embodiments may be considered as a method that includes a sequence of procedures, or may be considered as a program to cause a computer to execute the sequence of procedures or recording medium to store the program. As the recording medium, for example, a Compact Disc (CD), a Mini Disc (MD), a Digital Versatile Disc (DVD), a memory card, a Blu-ray (registered trademark) Disc, and similar medium can be employed.

What is claimed is:

1. An information-processing system, comprising:
a beacon device that transmits a beacon signal including identification information; and
a terminal device that causes an application to operate, the application performing processes relating to the beacon signal, wherein
the terminal device includes,
a receiver that receives the beacon signal,
a storage unit that stores the identification information of the beacon signal as a waiting condition, the beacon signal being a waiting object, and
a processing unit that maintains the application in an operating state after a detection of entering or exiting a reception area of the beacon signal that satisfies the waiting condition until a predetermined time period has passed, wherein
the storage unit stores a comprehensive waiting condition and an individual waiting condition as the waiting conditions, the comprehensive waiting condition comprehensively indicating the identification information different from one another, the individual waiting condition individually indicating a single piece of the identification information, and
the processing unit causes the storage unit to store the identification information of the beacon signal as the individual waiting condition, in a case where the processing unit detects entering the reception area of the beacon signal that satisfies the comprehensive waiting condition.

2. The information-processing system according to claim 1, wherein
in a case where the processing unit detects exiting the reception area of the beacon signal that satisfies the individual waiting condition, the processing unit causes the storage unit to delete the identification information of the beacon signal stored as the individual waiting condition.

3. The information-processing system according to claim 2, wherein
in a case where the processing unit detects exiting the reception area of the beacon signal that satisfies the individual waiting condition, if the receiver is still receiving the beacon signal that satisfies the comprehensive waiting condition, the processing unit causes the storage unit to store the identification information of the beacon signal as the individual waiting condition.

4. The information-processing system according to claim 1, wherein
the beacon device changes the identification information as time passes.

5. The information-processing system according to claim 4, wherein
the beacon device changes only a part of a section of the identification information as time passes.

6. The information-processing system according to claim 4, wherein
the comprehensive waiting condition comprehensively indicates the identification information before and after the change.

7. A terminal device, comprising:
a receiver that receives a beacon signal, the beacon signal including identification information;
a storage unit that stores the identification information of the beacon signal as a waiting condition, the beacon signal being a waiting object; and
a processing unit that maintains an application in an operating state after a detection of entering or exiting a reception area of the beacon signal that satisfies the waiting condition until a predetermined time period has passed, the processing unit causing the application to execute processes relating to the beacon signal, wherein
the storage unit stores a comprehensive waiting condition and an individual waiting condition as the waiting conditions, the comprehensive waiting condition comprehensively indicating the identification information different from one another, the individual waiting condition individually indicating a single piece of the identification information, and
the processing unit causes the storage unit to store the identification information of the beacon signal as the individual waiting condition, in a case where the processing unit detects entering the reception area of the beacon signal that satisfies the comprehensive waiting condition.

8. A processing method of a terminal device that includes a storage unit storing identification information as a waiting condition, the identification information being included in a beacon signal, the beacon signal being a waiting object, the processing method comprising:
a step of receiving the beacon signal;
a step of maintaining an application in an operating state after a detection of entering or exiting a reception area of the beacon signal that satisfies the waiting condition until a predetermined time period has passed, and causing the application to execute processes relating to the beacon signal; and
a step of causing the storage unit to store the identification information of the beacon signal as an individual waiting condition among the waiting conditions when detecting entering the reception area of the beacon signal satisfying a comprehensive waiting condition among the waiting conditions, the comprehensive waiting condition comprehensively indicating the identification information different from one another, the individual waiting condition individually indicating a single piece of the identification information.
